(19) United States
(12) Patent Application Publication
(10) Pub. No.: US 2005/0196330 A1
(43) Pub. Date: Sep. 8, 2005

(54) Abatement device

(76) Inventor: Ronald Garnett, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/794,743

(22) Filed: Mar. 5, 2004

(51) Int. Cl. B01D 53/34; B01D 50/00

(52) U.S. Cl. 422/171; 422/173

(57) ABSTRACT

An abatement device that prevents substantial expansion of process gasses during the gas combustion process is provided.

### BACKGROUND

The present inventions are related to abatement devices that may be used, for example, to treat the emissions from semiconductor manufacturing processes. Abatement devices are use to treat a wide variety of process (or “waste”) gasses from manufacturing processes, such as chemical production and semiconductor manufacture, because the process gasses can be extremely toxic, explosive and/or corrosive and can cause severe environmental damage if released into the atmosphere without proper treatment. Conventional abatement devices frequently include a single combustion chamber and a wet scrubber. The single, relatively large combustion chamber is connected to a plurality of process lines. The process gasses passing through the plurality of process lines are reduced to their component parts in the combustion chamber. The output from the combustion chamber (or “residue gasses”) is fed into the wet scrubber. Particulates, acids and chemicals that are water soluble are removed by the wet scrubber.

The present inventor has determined that conventional abatement devices are susceptible to improvement. More specifically, the present inventor has determined that, in conventional abatement devices, gasses are allowed to expand in the combustion chamber. Such expansion reduces the temperature of the gasses and results in particulate formation. The particulates stick to the inner surface of the combustion chamber, build up, and ultimately clog the combustion chamber. The present inventor has also determined that conventional abatement devices are difficult to clean and maintain.

### BRIEF DESCRIPTION OF THE DRAWINGS

Detailed description of embodiments of the inventions will be made with reference to the accompanying drawings.

FIG. 1 is a schematic view of an abatement device in accordance with an embodiment of a present invention.

FIG. 2 is a side view of an abatement device in accordance with an embodiment of a present invention.

FIG. 3 is a partial section view of a firing chamber in accordance with an embodiment of a present invention.

FIG. 4 is a partial section view of a wet scrubber in accordance with an embodiment of a present invention.

FIG. 5 is a section view taken along line 5-5 in FIG. 4.

### DETAILED DESCRIPTION OF THE ILLUSTRATED EMBODIMENTS

The following is a detailed description of the best presently known modes of carrying out the inventions. This description is not to be taken in a limiting sense, but is made merely for the purpose of illustrating the general principles of the inventions. It should also be noted that detailed discussions of abatement devices that are not pertinent to the present inventions have been omitted for the sake of simplicity.

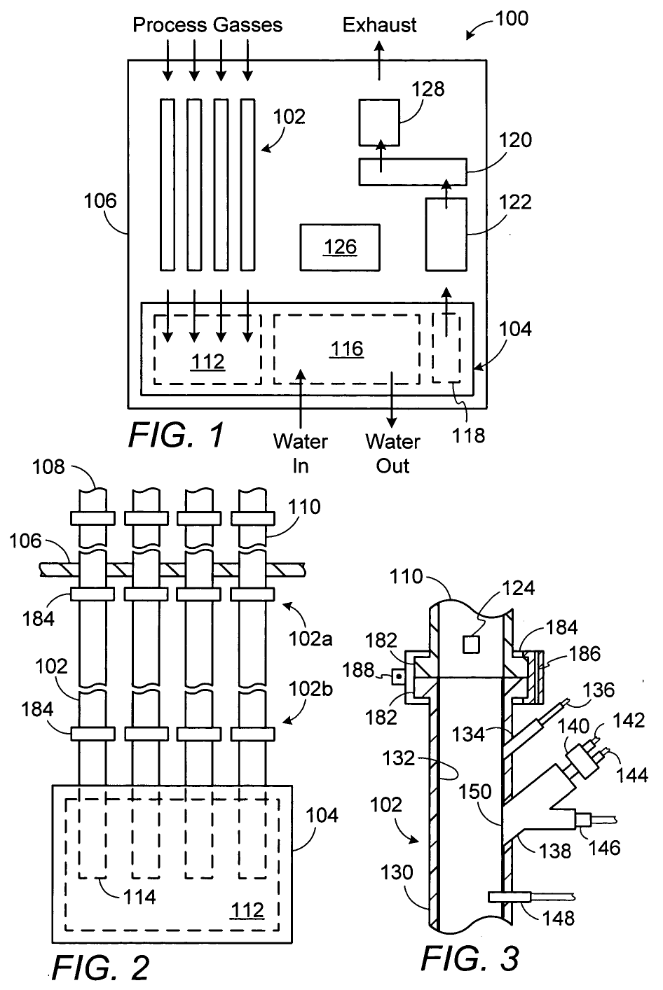

As illustrated for example in FIGS. 1 and 2, an abatement device 100 in accordance with one embodiment of a present invention includes a plurality of individual firing chambers 102, which together define a combustion apparatus, and a scrubber 104 that may be located within a housing 106. The abatement device 100 also includes a plurality of individual inlets that respectively receive process gasses such as, for example acid exhaust, from a plurality of individual process lines. In the illustrated embodiment, each firing chamber 102 is connected to an individual process line pipe 108. Individual connector pipes 110, which act as inlets to the abatement device 100, may be used to connect each of the firing chambers 102 to the individual process line pipes 108. Such connector pipes 110 extend outwardly from the housing 106 for connection to the process line pipes 108. The firing chambers 102 may, alternatively, be directly connected to the individual process line pipes 108. Here, the portions of the firing chambers 102 adjacent to the process line pipe outlets would act as the abatement device inlets. In either case, and as discussed in greater detail below, the cross-sectional area of the gas flow path through each firing chamber 102 and connector pipe 110 (if present), will be same as the cross-sectional area of the gas flow path through the process line pipes 108 to which they are connected. This prevents expansion of the process gasses within the firing chambers 102.

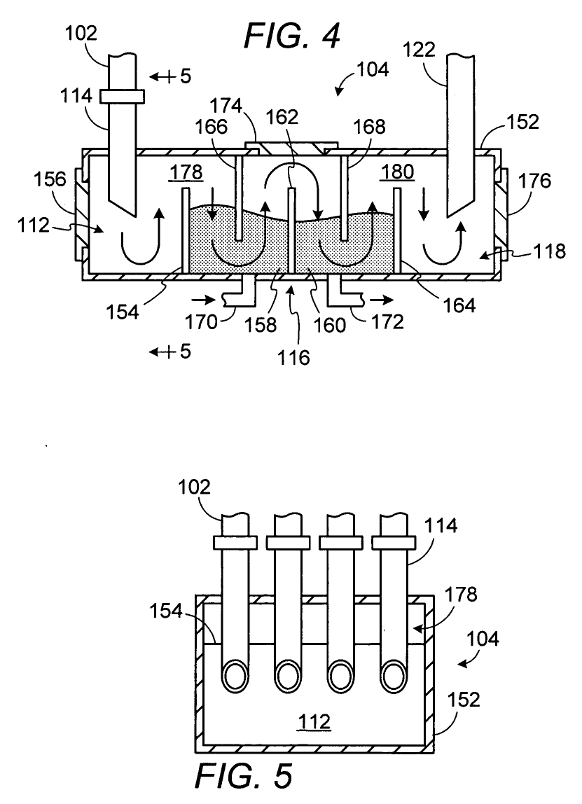

Expansion of the process gasses takes place post-combustion (and downstream from the firing chambers 102) in an expansion chamber 112 which, in the exemplary embodiment, is located within the scrubber 104. Here, the residue gasses from the firing chambers expand and precipitate out solid materials in the manner discussed below with reference to FIGS. 4 and 5. The firing chambers 102 are connected to the expansion chamber 112 by connector pipes 114 that extend into the expansion chamber. The gas flow paths through the connector pipes 114 preferably have the same cross-sectional areas as the respective firing chambers 102 to which they are connected in order to prevent expansion prior to the expansion chamber 112. Alternatively, the connector pipes 114 may be eliminated by extending the firing chambers 102 into expansion chamber 112. Referring to FIG. 1, the residue gasses pass from the expansion chamber 112 into a wet scrubbing area 116. Here, the water soluble residue gasses will be absorbed in the manner discussed below with reference to FIGS. 4 and 5. The residue gasses then flow through a final collecting chamber 118, where additional solid precipitation takes place before the residue gasses exit the exemplary scrubber 104.

A blower 120 (FIG. 1), which is connected to the final collecting chamber 118 by an inlet line 122, is used to draw the process gasses through the exemplary abatement device 100. The volumetric flow rate through the abatement device 100 should be such that the resident time of the process and residue gasses within the firing chambers 102 and scrubber 104 is optimized and consistent. To that end, the speed of the blower may be varied based on factors such as the inlet pressure at the firing chambers 102. Pressure sensors 124 (FIG. 3) may be used to monitor the inlet pressure at the firing chambers 102 and the sensed pressure data may be provided to a controller 126. The controller 126 will, in turn, vary the speed of the blower 120 as necessary to maintain the desired volumetric flow rate. An outlet pipe 128 vents the gasses out of the abatement device 100 after the scrubbed residue gasses have passed through the blower 120. In some instances, and depending on the type facility in which the abatement device 100 is employed, the scrubbed residue gasses will be treated with other, less caustic “house” exhaust, before being released into the atmosphere.

Turning to FIG. 3, the exemplary firing chambers 102 may be formed from a length of pipe 130 such as KF40 pipe (1 ¾ inch ID) or KF50 pipe (2 ¼ inch ID), depending on the size of the process line 108 to which they are connected. It should be noted that KF pipe is also referred to as NW pipe. Although the exemplary pipe 130 is circular in cross-section, it should also be noted that the present firing chambers are not limited to any particular cross-sectional shape. Other types of conduits, such as square tubing, may be used in place of the pipes 130 as applications require or permit. The length of the exemplary firing chambers 102 will typically be about 12 inches to about 18 inches, although the actual length will depend on the intended application. A thin insulation liner 132, such as a ceramic or quartz liner, may positioned about the inner surface of the pipe 130 in order to protect the pipe from the relatively high temperatures (e.g. about 1000° C. or more) that can be required to break down perfluorocarbons and the like. The insulation liner 132 will only be about 3/16 of an inch thick and, therefore, will not substantially decrease the cross-sectional area of the gas flow path defined by the pipe 130. With or without the insulation liner 132, the cross-sectional area of the gas flow path through each exemplary firing chamber 102 will be constant from the firing chamber inlet 102a (FIG. 2) to the firing chamber outlet 102b. This prevents expansion of the process gasses and post-combustion residue gasses within the firing region of the abatement device 100, i.e. the region between the inlets 102a and the outlets 102b.

The exemplary firing chambers 102 include an enriching fuel port 134 that is connected to a fuel supply line 136, and a burn nozzle 138 that is connected to an air/fuel mixing chamber 140. The air/fuel mixing chamber 140 is connected to a fuel supply line 142 and an oxygen supply line 144. In the exemplary implementation, the fuel supply lines 136 and 142 supply hydrogen or methane to the enriching fuel port 134 and air/fuel mixing chamber 140, while the oxygen supply line 144 supplies oxygen or air to the air/fuel mixing chamber. An ignition device 146, such as a glow plug, may be used by the burn nozzle 138 to ignite the air/fuel mixture, thereby producing a flame which extends into the gas flow path within the pipe 130. A thermocouple 148 (or other temperature sensor) is positioned adjacent to the burn nozzle outlet 150.

During the combustion process, the enriching fuel ports 134 add fuel to the process gasses as they enter the firing chambers 102. The enriching fuel insures that the process gasses will be sufficiently combustible when they reach the flame from the burn nozzle 138. Heat from the flame destroys the process gasses by breaking them down into their component parts. Additionally, because the cross-sectional area of the flow path through the firing chamber 102 is the same as that of the associated process line pipe 108, and is constant from the inlet 102a to the outlet 102b, the process and residue gasses will not be able to expand. This prevents the gasses from cooling. As a result, particulate formation and, ultimately, clogging of the firing chambers 102 caused by particulate buildup is prevented.

The combustion process within the firing cambers 102 is monitored and controlled by the controller 126. For example, temperature information from the thermocouple 148 in each firing chamber 102 may be monitored. In those instances where there is a sudden spike to an extremely high temperature at a thermocouple 148, the combustion process may be halted by cutting of the flow of fuel to the enriching fuel port 134 and the air/fuel mixing chamber 140 and turning off the ignition device 146 of the associated firing chamber 102. A valve (not shown), such as a pressure, pneumatic or manual valve, that is located upstream from the abatement device 100 will also be closed or otherwise adjusted to prevent the flow of process gasses to the particular firing chamber 102. Preferably, the valve will be a three-way valve that will redirect the process gasses to the “house” exhaust line. Temperature information from the thermocouples 148 may also be used to simply increase or decrease the supply of fuel to the enriching fuel port 134 and/or the air/fuel mixing chamber 140 of the associated firing chamber 102.

As discussed above with reference to FIGS. 1 and 2, an expansion chamber is provided in a predefined area downstream from firing chambers 102, thereby providing a location outside of the firing chambers for the residue gasses (i.e. the component chemical parts of the process gasses as well as any gas or other matter that was burned) to expand and cool. The expansion chamber may be a stand alone device within the abatement device housing 106. Alternatively, in the illustrated embodiment, the expansion chamber 112 is part of the scrubber 104. There are a number of advantages associated with having a predefined expansion area downstream from the firing chambers 102. Most notably, solid materials will not precipitate out of the process gasses within the firing chambers 102 and clog the firing chambers. It is also possible to place the expansion area in a position within the housing 106 that will be readily accessible to make solid material removal easier.

Turning to FIG. 4, the exemplary scrubber 104 includes a housing 152 in which the expansion chamber 112, wet scrubbing area 116 and final collecting chamber 118 are located. The exemplary housing 152 is rectangular in cross-section and about 36 inches long, about 20 inches high and about 18 inches wide. Internally, the expansion chamber 112 is about 10 inches long, the wet scrubbing area 116 is about 21 inches long, and the final collecting chamber 118 is about 5 inches long. Alternatively, the housing 152 may be circular in cross-section.

The expansion chamber 112 is defined by the walls of the housing 152 and a baffle 154 that extends from one side of the housing to the other. Access to the expansion chamber 112, and the particulates that precipitate out of the residue gasses as they expand within the expansion chamber, is provided by an access panel 156.

The wet scrubbing area 116 in the exemplary implementation includes first and second wet scrubbing chambers 158 and 160 which contain fluid during use. The first wet scrubbing chamber 158 is defined by the walls of the housing 152, the baffle 154 and a baffle 162, and the second wet chamber 160 is defined by the baffle 162 and a baffle 164. Baffles 166 and 168 extend downwardly from the top of the housing 152. Each of the baffles 162-168 extends from one side of the housing 152 to the other. The wet scrubbing area 116 is also packed with a media, such as plastic, marble or limestone balls (not shown), and is partially filled with water. The balls may also be treated with a chemical that neutralizes the acid content within the residue gas. The water, which is delivered to the wet scrubbing area 116 through a supply line 170 and is removed through an outlet line 172, flows from the first wet scrubbing chamber 158 to the second wet scrubbing chamber 160 by way of openings (or “bleed ports”) that are located at the bottom of the baffle 162. The water delivery and removal may be periodic or continuous. An access panel 174 provides access to the wet scrubbing area 116 for maintenance, particulate removal and repair.

The expansion chamber 118 is defined by the baffle 164 and the housing 152. Access to the expansion chamber 118, and particulates that precipitate out of the residue gasses within the expansion chamber 118, may be obtained by way of an access panel 176 for maintenance, particulate removal and repair.

The access panels 156, 174 and 176 in the exemplary implementation are secured to the scrubber housing 152 with machine bolts and nuts. The abatement device housing 106 is provided with a front door (not shown), as well as removable access panels on the sides and rear (not shown), to provide access to the access panels 156, 174 and 176.

During use, gasses that have passed through the firing chambers 102 and connector pipes 114 without expanding will flow into the scrubber 104 and, more specifically, into the expansion chamber 112. The residue gasses expand and cool within the expansion chamber 112. Heavier residue gasses, such as phosphines, silines, dieborines, chlorines, arsines and freons, that are saturated with process solid particulates and residues, precipitate out the heavier solid materials. This solid materials accumulate within the expansion chamber 112 and may be removed during maintenance processes through the access panel 156. Additionally, it should be noted that the downward orientation of the connector pipes 114 and position of the inlet 178 to the wet scrubbing area 116 forces the residue gasses to follow an S-shaped flow path. Such a path increases the distance that the residue gasses will travel prior to reaching the wet scrubbing area 116, thereby increasing the amount of heavy particulates that precipitate out of the gasses within the expansion chamber 112.

The residue gasses will then enter the wet scrubbing area 116 where the plastic, marble or limestone balls (or other media) break up the gas flow and increase the distance that the residue gasses travel through the water. Similarly, the baffles 162, 166 and 168 force the residue gasses to follow a serpentine flow path and further increase the distance that the gasses travel as they pass through the first and second wet scrubbing chambers 158 and 160. The water within the wet scrubbing area 116 absorbs the light, water soluble gasses in the residue gasses. The water that is contaminated in wet scrubbing area 116 will typically be sent to a chemical wastewater treatment facility.

After exiting the wet scrubbing area 116 by way of an outlet 180, the remaining residue gasses follow an S-shaped flow path through the final collecting chamber 118. Here, the residue gasses continue to expand and any remaining particulates will precipitate out of the gasses.

The exemplary abatement device 100 is also a modular device which allows portions of the abatement device to be easily removed and/or replaced. As illustrated for example in FIG. 3, and as discussed above, the firing chambers 102 may be formed from KF40 or KF50 pipe 130. Such pipes include connector flanges 182 at each end. The process line pipes 108, connector pipes 110 and connector pipes 114 in the exemplary embodiment are formed from the same type of pipe as the firing chambers 102 (i.e. KF40 or KF50 pipe) and these pipes also include connector flanges 182. Releasable fasteners, such as the illustrated quick disconnect clamps 184 (FIGS. 2 and 3), may be used to secure the firing chambers 102 to the connector pipes 110 and 114. Such clamps, which may be obtained from Nor-Cal Products in Yreka, California, include pivot pins 186 on one side and locks 188 on the other. The fuel and oxygen lines 136, 142 and 144 are also connected to the firing chamber 102 in such as manner that they can be easily connected to, disconnected from, the firing chamber. Similarly, the electrical connectors that connect the ignition device 146 and thermocouple 148 to the associated wiring are capable of being easily connected and disconnected.

As a result of the connection scheme described above, the firing chambers 102 may be readily and individually connected and disconnected from the connector pipes 110 and 114 (and the abatement device 100) for service or replacement as necessary. One firing chamber 102 may be removed from the abatement device 100 while others continue to operate.

Although the present inventions have been described in terms of the embodiments above, numerous modifications and/or additions to the above-described embodiments would be readily apparent to one skilled in the art. By way of example, but not limitation, the various components of the exemplary fuel cartridges described above may be interchanged. It is intended that the scope of the present inventions extend to all such modifications and/or additions.

1. An abatement device, comprising:
a plurality of abatement device inlets adapted to be respectively connected to a plurality of process lines; and
a plurality of individual firing chambers respectively operably connected to the plurality of abatement device inlets.

2. An abatement device as claimed in claim 1, further comprising:
a housing;
wherein the plurality of firing chambers are located within the housing.

3. An abatement device as claimed in claim 1, wherein at least one of the firing chambers defines an inlet, an outlet and a substantially constant cross-sectional area from the inlet to the outlet.

4. An abatement device as claimed in claim 1, wherein the firing chambers include respective burn nozzles.

5. An abatement device as claimed in claim 1, further comprising:
an expansion chamber operably connected to the firing chambers.

6. An abatement device, comprising:
a plurality of process line inlets that receive process gas;
means, operably connected to the process line inlets, for preventing the process gas from substantially expanding;
means for burning the process gas to produce residue gas; and
means for preventing the residue gas from substantially expanding.

7. An abatement device as claimed in claim 6, further comprising:
a housing;
wherein the means for preventing the process gas from substantially expanding, means for burning the process gas, and means for preventing the residue gas from substantially expanding are located within the housing.

8. An abatement device as claimed in claim 6, further comprising:
an expansion chamber operably connected to the means for preventing the residue gas from substantially expanding.

9. An abatement device, comprising:
a plurality of abatement device inlets adapted to be respectively connected to a plurality of process lines;
a combustion apparatus configured to prevent substantial expansion of process gas, burn the process gas to produce residue gas, and prevent substantial expansion of the residue gas;
an expansion area, located downstream from and operably connected to the combustion apparatus, configured to allow expansion of the residue gas; and
a wet scrubbing area, located downstream from and operably connected to the expansion area, including liquid that absorbs portions of the residue gas.

10. An abatement device as claimed in claim 9, wherein the expansion area and wet scrubbing area are located within a scrubber housing.

11. An abatement device as claimed in claim 10, wherein the expansion area and wet scrubbing area are separated by a baffle.

12. An abatement device as claimed in claim 10, wherein the scrubber housing includes an access panel adjacent to the expansion area.

13. An abatement device as claimed in claim 9, wherein the combustion apparatus comprises a plurality of firing chambers respectively connected to the plurality of process lines.

14. An abatement device as claimed in claim 13, wherein the firing chambers define respective inlets, outlets and gas flow paths with cross-sectional areas and the cross-sectional areas of the gas flow paths are substantially constant from the inlets to the outlets.

15. A method of treating process gas, comprising the steps of:
receiving the process gas in a firing chamber;
preventing the process gas from substantially expanding within the firing chamber;
burning the process gas to produce a residue gas; and
preventing the residue gas from substantially expanding within the firing chamber.

16. A method as claimed in claim 15, further comprising the step of:
allowing the residue gas to expand in an expansion chamber downstream from the firing chamber.

17. A method as claimed in claim 15, further comprising the step of:
allowing the residue gas to expand in an expansion chamber located within a wet scrubber.

18. A method as claimed in claim 15, wherein the step of receiving process gas in a firing chamber comprises receiving process gas from a plurality of process lines in a corresponding plurality of firing chambers.

19. A method as claimed in claim 15, wherein the burning the process gas comprises burning the process gas with a flame within the firing chamber to produce a residue gas

20. A method of treating process gas, comprising the steps of:
transferring process gas from a plurality of process lines to a respective plurality of firing chambers in a single abatement device; and
burning the process gas within the firing chambers.

21. A method of treating process gas as claimed in claim 20, further comprising the step of:
preventing the process gas from substantially expanding within the firing chambers.

22. A method of treating process gas as claimed in claim 21, wherein the step of burning process gas produces residue gas, the method further comprising the step of:
preventing the residue gas from substantially expanding within the firing chambers.

23. A method of treating process gas as claimed in claim 22, further comprising the step of:
allowing the residue gas to expand in an expansion chamber downstream from the firing chamber.

24. A method of treating process gas as claimed in claim 20, wherein the step of burning the process gas comprises burning the process gas with respective flames within the firing chambers.

25. A wet scrubber, comprising:
an expansion chamber; and
a fluid containment area having a gas inlet operably connected to the expansion chamber and a gas outlet.

26. A wet scrubber as claimed in claim 25, further comprising:
a fluid inlet and a fluid outlet operably connected to the fluid containment area.

27. A wet scrubber as claimed in claim 25, further comprising:
a collection chamber operably connected to the gas outlet.

28. A wet scrubber as claimed in claim 25, further comprising:
a plurality of baffles within the fluid containment area.

29. A wet scrubber as claimed in claim 28, wherein the baffles define a substantially serpentine path through the fluid containment area.

30. A wet scrubber as claimed in claim 25, further comprising:
an access panel associated with the expansion chamber.

31. A wet scrubber as claimed in claim 25, wherein fluid containment area and the expansion chamber define respective volumes and the volume of the fluid containment area is larger than the volume of the expansion chamber.

32. An abatement device, comprising:
a firing chamber; and
a wetter scrubber including
an expansion chamber operably connected to the firing chamber, and
a fluid containment area having a gas inlet operably connected to the expansion chamber and a gas outlet.

33. An abatement device as claimed in claim 32, comprising:
a fluid inlet and a fluid outlet operably connected to the fluid containment area.

34. An abatement device as claimed in claim 32, further comprising:
a collection chamber operably connected to the gas outlet.

35. An abatement device as claimed in claim 32, further comprising:
a plurality of baffles within the fluid containment area.

36. An abatement device as claimed in claim 35, wherein the baffles define a substantially serpentine path through the fluid containment area.

37. An abatement device as claimed in claim 32, further comprising:
an access panel associated with the expansion chamber.

38. An abatement device as claimed in claim 32, wherein fluid containment area and the expansion chamber define respective volumes and the volume of the fluid containment area is larger than the volume of the expansion chamber.

39. An abatement device, comprising:
a plurality of sets of inlet and outlet conduits;
a plurality of firing chambers; and
means for releasably connecting the firing chambers to respective sets of inlet and outlet conduits.

40. An abatement device as claimed in claim 39, wherein the firing chambers, inlet conduits and outlet conduits comprise pipes.

41. An abatement device as claimed in claim 39, wherein the firing chambers, inlet conduits and outlet conduits comprise pipes of the same type.
